(19) United States
(12) Patent Application Publication
(10) Pub. No.: US 2010/0064331 A1
(43) Pub. Date: Mar. 11, 2010

(54) Hybrid Premium Terrestrial Television Service

(76) Inventor: Robin Ross Cooper, La Mesa, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/555,760

(22) Filed: Sep. 8, 2009

Related U.S. Application Data
(60) Provisional application No. 61/095,303, filed on Sep. 8, 2008.

(51) Int. Cl. H04N 7/173

(52) U.S. Cl. 725/109

(57) ABSTRACT

A method for the provision of a hybrid premium television platform using terrestrial broadcasting. The system allows for enhanced services to subscribers using a terrestrial broadcast signal. The enhanced services are similar to those enjoyed by more expensive providers such as cable and satellite television providers.

### FIELD OF THE INVENTION

This application claims priority to U.S. Provisional Patent Application No. 61/095,303 filed Sep. 8, 2008 and which is incorporated herein in its entirety by reference.

The disclosed invention relates to the provision of television programming. More particularly it relates to a hybrid premium television platform targeted toward global emerging markets offering enhanced television services at the lowest possible prices.

### BACKGROUND OF THE INVENTION

In the past, television services have been offered in various tiers. The more a subscriber is willing to pay, the more services, options, and quality of service (QOS) the subscriber receives.

Over the last 40 years, the tiers have been roughly defined as: analog terrestrial, satellite (digital), analog cable and digital cable. Within the first decade of the 21st century, a number of new emerging technologies are being offered that will soon make a huge impact on the premium television landscape. These emerging technologies are: IP-Television, digital terrestrial (often referred to as ATSC for the United State and South Korea and DVB-T for the rest of the world. Japan and Brazil use ISDB-T but these represent a much smaller market), and the Internet.

It is an object of this patent application to describe the methods and systems and devices which will enable the disclosed hybrid premium television platform to exist and operate.

It is well known that the most populated of countries will soon discontinue analog television broadcasts in order to provide more spectrum for wireless services. As analog television requires a huge amount of spectrum, the process of freeing-up this bandwidth will create huge revenues for all wireless stakeholders especially as new and advanced wireless applications appear in the marketplace.

Instead of discontinuing terrestrial television services completely, the countries are providing digital terrestrial television as a replacement service. Since the broadcast signals are digital, compressed video can be used (MPEG) and the bandwidth requirements can be reduced significantly. It is important to note that these digital terrestrial signals can easily carry high-definition (HD) digital television signals at resolutions of 1080 p.

In addition, numerous HD channels can be offered to consumers within their communities. Therefore, some of the best quality television can be obtained “free-to-air” using these digital terrestrial services. At the time of this writing, there are two different digital terrestrial services in the world. The U.S., South Korea and a few other countries use the ATSC standard. Most of the other countries around the world use the DVB standard. For the purposes of this patent application, either type of standard or service can be employed in conjunction as with the disclosed device and method.

As new consumers make their decisions about television services moving forward, many will decide that digital terrestrial television coupled with “content-on-demand” offerings and Internet connectivity may offer the most efficient offering for their needs. Even though these consumers may only receive a maximum of 20 channels of terrestrial or “free-to-air” programming, these may be the only channels they need given their knowledge of competing services. Thus, an enhanced terrestrial delivery system for such consumers would be an important advance.

### SUMMARY OF THE INVENTION

The following summary is provided for use in combination with the detailed description of the preferred embodiments of the system and apparatus herein. For the purposes of this patent application, a Hybrid Television Service should best be considered as a high-quality “free-to-air” digital terrestrial service combined with “on-demand” content offerings, compelling media applications, and hardware mechanisms and devices local to the consumer that can create a low-cost integrated package that is compelling to multitudes of television viewers world wide.

The most compelling offering is called the “Hybrid—Connected”. This system will connect itself to the Internet given a wireless or hardwired connection. Once the “Hybrid-Connected” can log-on then a multitude of content services can be accessed with relative ease.

The “Hybrid—Not Connected” relies on the well-known “trickle-down” method (such as used by various satellite service operators). Content is “trickled” into consumer devices over a period of time. Once enough content has been successfully “trickled”, then the consumer will find valuable content offerings local to his or her own consumer device.

Although it is difficult for consumer responses (and other information) to be transferred back to a head-end facility if the consumer is not connected to a network, there are a few methods that can be used as follows:

1. A consumer can make a phone call, a mobile phone call to a service operator on a periodic basis in order to convey information to a service operator.

2. A consumer device (such as a set-top-box) can be connected to a POTS (telephone) line in order to make periodic calls to a service operator for the purposes of conveying information.

3. A consumer can send SMS or email messages to a service operator on a periodic basis in order to convey information.

4. Questionnaires and requests can be prepared and mailed or faxed to a service operator.

5. Other consumer-generated actions can be initiated in order to convey information to the service operator. (Example—walk into a retail facility established by the service operator, etc.)

Conveying information may include the paying of bills, requesting content downloads in numerous ways, requesting upgrades in services, or answering questions that might be asked by the service operator.

There are a few methods for “trickling” content to a consumer device as follows:

1. Data can be added into the Vertical Blanking Interval (VBI) so consumer devices can obtain this information and store it appropriately.

2. Services such as offered by the company “Update Logic”, located in Southborough, Mass., can use a small part of the broadcast spectrum to “trickle” content into consumer devices on a periodic basis. Companies such as “Update Logic” have already made significant investments in licensing public spectrum for the purpose of providing value-added services to a large base of potential customers.

Advertising has always played a key role in subsidizing the distribution of television. Consequently, advertising will continue to subsidize television especially when it is being provided to mass audiences at little or no charge.

It is also well known that “Targeted” advertising yields enormous premiums as follows:

1. Advertisers are motivated to pay higher CPMs (Cost-Per-Thousands) as the number of impressions may be smaller, however, the impact may be significantly higher.

2. In the future, advertisers may not pay much more on a CPM basis as they do today, however, they will not advertise at all unless (at least a certain level of) targeting can be achieved.

By the employment of the disclosed Hybrid Premium Terrestrial Television Service, targeted advertising will be achieved using the following methods:

1. Overlays (video or text) can be placed on a designated portion of the video screen in association and coordination of the advertiser. For example, an advertiser may wish to target a certain demographic audience with extra information (possibly including an incentive such as a coupon) by overlaying information in an appropriate area of the screen. (Or at least in an area of the screen that is the most effective, however, least intrusive.)

2. Overlays (video or text) can be placed on a designated portion of the video screen without the consent or knowledge of the advertiser. Although this is not a preferred embodiment, this function can be performed on behalf of communities and government agencies and may be acceptable given certain specific scenarios. (For example, an advertisement for “Gamblers Anonymous” may be displayed as an overlay to an advertisement for a gambling casino.)

3. “In-Broadcast” splicing can be achieved where a targeted advertisement is spliced directly into the broadcast stream itself (MPEG) so a targeted ad will be displayed instead of the “shot-gun style” advertisement directed to the rest of the viewing audience.

4. “On-Demand” splicing (or concatenating) can be achieved by joining one or more advertising video clips (assets) with the content offering selected by the consumer. This is typically a good approach for front-roll “On-Demand” content offerings.

5. Pop-up buttons and other navigation tools can be displayed, allowing a consumer to see extended offerings (i.e. coupons or other incentives that might be offered by the advertiser) in a pop-up button that can be “pressed” or otherwise manipulated by the consumer.

6. Targeted advertising can also be provided as consumers view an Electronic Program Guide (EPG) or other navigational applications provided by “Middleware” systems. Such advertising can be accomplished by allowing text or video to be displayed as consumers are searching or selecting various content offerings.

In a preferred embodiment, the invention described in this patent application will scan the digital data coming in for markers that define the starting point for advertisements. These starting points are often tones sometimes referred to as Q-Tones or Digital Program Insertion points (DPI). Non-standard insertion flags can also be used to instruct the system to place an advertisement at a certain point within the digital stream. Once an advertisement is detected one of the following may occur:

1. A targeted video ad may appear instead of the intended ad.

2. A targeted video ad may appear within a separate window as the intended ad plays unobstructed.

3. A pop-up graphic may appear instead of the intended ad.

4. A pop-up graphic may appear within a separate window as the intended ad plays unobstructed.

5. Other “On Screen Data” may appear on the display instead of the intended ad.

6. Other “On Screen Data” may appear within a separate window or area of the screen as the intended ad plays unobstructed.

A consumer will most likely need an antenna to capture data coming from a digital terrestrial transmission. Although it is a marketing myth that consumers need to purchase high-end antennas (and other antenna equipment), there is no difference between an analog antenna and a digital terrestrial antenna. In a preferred embodiment, an antenna will be used for such a service to provide the consumer with the best possible television viewing experience.

It should be noted that digital terrestrial transmissions are less forgiving than analog signals. Therefore, either the consumer needs to verify the antenna is located properly, or the video service provider must deliver a stronger signal to the target population of consumers.

Although the Set-Top-Box (STB) may remain the single most popular method for receiving content and displaying it (often on a large display), mobile devices and personal computers (PCs) will become more important as television reception devices as the years progress.

This disclosed system and apparatus employs methods, systems, and devices for all four current-day terminal devices (Television sets, STBs, Mobile devices, and PCs) in order for Hybrid Television services to be offered efficiently and at low costs to consumers.

The Hybrid Set-Top-Box is one of the most important components of this system. Although a television set can be fully equipped to the point where a Set-Top-Box is not needed, it is assumed most consumers will use a Set-Top-Box within the early decades of the 21st century as this allows for a wider selection of television sets (which typically yields lower costs). Although viewing habits have started to change among young people (using more mobile devices and PCs), it is still the case most of the television viewing audience world-wide watches TV in front of a television set, and such a television set needs the additional features and capabilities of Set-Top-Box. For example, a typical television set today can only receive uncompressed analog video. Therefore, extra components are required to capture digital television information and convert it into analog video.

There are three versions of such a set-top-box as described below. First, the “Low-End” set-top-box will be defined by its very limited feature set. The most significant limitation being its inability to make a network connection of any kind. Although this version of set-top-box is capable of receiving content and other types of data from broadcast signals, it has no way to interactively connect to a larger network in order to take advantage of more sophisticated services and applications. This set-top-box can be manufactured in such a way as to make its cost low enough to be attractive to millions of consumers world wide. In fact, an advertising campaign can be based on providing free set-top-boxes to a population of consumers as long as they tolerate a certain level of advertising from time to time.

The “Standard” set-top-box will be differentiated from the “Low-End” set-top-box as it will be manufactured with a methods, components, and systems for connecting to a larger, interactive network. This “Standard” set-top-box will be equipped with one of the following:

1. A POTS connection for the set-top-box to periodically dial its command center and use standard telephone equipment to send and receive data.

2. An Ethernet (or similar) connection that will allow for higher-speed throughput of data without the need to place a telephone call.

3. A wireless connection that will search for WIFI (or Wi-Max) signals and use these same WIFI (or Wi-Max) signals to send and receive data using speeds that are similar to Ethernet speeds.

4. Any combination of the items mentioned above.

Finally, the “High-End” set-top-box will be differentiated from the “Standard” set-top-box by its extra features including (but not limited to):

1. Additional storage capacity

2. Optical Disc capability (using red laser, blue laser, or both)

3. Other higher-end functions within the set-top-box and its remote control unit.

Both the “Standard” set-top-box and the “High-End” set-top-box can additionally offer plug-in slots for expanded storage. For example, slots for flash memory devices can be offered that will allow the set-top-box store significantly more information. This expansion capability can help to provide valuable storage resources on an “as-need” basis. In addition extended memory devices can also be used to load new applications and data files needed to further enhance the television (or game) experience for the consumer.

It should be noted that expansion memory can take multiple forms including (but not limited to) USB dongles, flash cards, external disc drives, Apple iPod units, and others.

The set-top-box can additionally be outfitted with features that will render it into a game console suitable for “casual” gaming. Casual games are defined as games which require low interactivity and weak graphics processing. These include games such as Solitaire, Minesweeper, Poker, Trivia games, etc. For example, by adding more control functions on the remote control unit and by tracking the instructions provided by the consumer and passing these same instructions on to the game software, this relatively low-cost set-top-box can serve as a multi-function television remote control and game console combined.

In an alternate mode of the method and device, a game console such as a Sony PS3, a Nintendo Wii, or an Xbox can become a set-top-box for the invention described in this patent application as long as these devices can support an external hardware device that can capture digital terrestrial television signals and appropriately coordinate with the television set to render these signals on the television screen.

In the near future, television set manufacturers will begin to supply television sets that will not need a set-top-box of any kind. The appropriate systems and components will be included in the television set, and the television set itself will be all that is needed to enjoy the best possible viewing experience. It is important to note that this patent application can work with a set-top-box and with a television set appropriately equipped with set-top-box capabilities.

For terminal devices with any type of back channel (automated or manual), it will be important to collect and report consumer-level profile and usage information to the service operator on a regular basis. The service operator can then use this information to create groupings of profiles in such a way that advertisers can target their ads more effectively. Some of the data elements that can be collected from the consumer and reported to a service operator are as follows:

1. Channel change information

2. Video-On-Demand title selections

3. Other content purchases or viewings

4. Answers to on-screen prompts (provided by the consumer)

5. Consumer information captured from billing processes

6. Other consumer-level information that can be captured.

For some of the targeted ads that appear to the consumer, a “Pop-Up” display (or button) can prompt the consumer to purchase the product. If the consumer responds positively to the “Pop-Up” display, then the product can be purchased. Once the consumer purchases the produce, the consumer will be charged appropriately (by way of credit card, ATM card, or other), and the product can be shipped.

“On-Demand” content selections can be made using the “Trickle-Down” method as described above, for terminal devices with no backchannel. Such a “Trickle-Down” method would pre-load content titles on long-term storage medium within the terminal device allowing a consumer to view the available titles and make selections to view (or otherwise enjoy) the titles that have been selected. The service operator can be notified of the selection of titles in numerous ways including (but not limited to) the following:
1. Mobile phone can be used (voice call or SMS) to receive a “key” for the title. Once the “key” is delivered, the consumer is charged appropriately for the viewing (or enjoyment) of the content title.
2. Email can also be used to receive a “key” for the title. Once the “key” is delivered, the consumer is charged appropriately for the viewing (or enjoyment) of the content title.
3. Coupons can be obtained by way of kiosks or sale “over the counter” from a retail establishment.
4. The postal service can also be used to request “keys” be sent to the consumer.
5. Any other method that would allow a consumer to enjoy a content title given the terminal device has no backchannel.

For terminal devices with a backchannel, standard cryptographic methods and systems can be used to appropriately request “keys” securely and have these “keys” delivered in a timely fashion. Once a “key” is delivered to a terminal device, the consumer is appropriately charged for the title(s).

The system described in this patent application can work with real-time “streaming” data or with data being downloaded over time. It is well known that streaming data assumes a robust network that can deliver content on a consistent basis. Data being downloaded can withstand more fault conditions and errors, however, consumers will still expect reasonable delivery speeds. The important thing to note is both streaming and downloading of content data is supported by the systems defined in this patent application.

Given enough memory storage capacity, low-cost terminal devices can support “Pause” TV. Such a “Pause” TV model allows the consumer to pause the playout of the content for a period of time. Once the consumer is ready to continue playing the content, all that is required is the pushing of a “PLAY” button (or similar button on the device or a remote control unit).

If “Pause” TV is supported by the terminal device, then it is also possible for the terminal device to provide REWIND and FAST FORWARD functions as well. All of these functions are simply the result of using available memory (as memory buffers) in such a way as to provide a seamless media enjoyment experience for the consumer.

In the case of “Pause” TV, the content will be forwarded to memory storage rather than to the screen (or other playout device). When the consumer is ready to resume, the content will be directed from memory storage to the screen (or other playout device) until the content is fully consumed.

Once the content has been fully consumed, the consumer may have the ability to select an option such as follows:

Erase the content title

Save the content title to the current device

Save the content title to another device

Play the content title once again

Other options.

It is important to note that Digital Rights Management (DRM) systems may only permit consumers to perform certain functions with their valuable content (as allowed by the content owners). When content is protected by one or more of these DRM systems, the number of options may be greatly reduced.

It is well known that consumers are becoming familiar with “On Demand” content experiences. Consumers have no problem loading iPods with content selections, making personalized playlists, and playing their content in such a way that may be truly unique in the world. At the time of this writing, consumers appear to be well on their way to enjoying music in a personalized manner, and television is soon to follow.

With the success of websites such as the popular YouTube (and others), we can now see that consumers will soon start to enjoy the television viewing experience in more of an “On Demand” fashion as well. For this reason, literally millions of content selections are being loaded on to server systems that are connected to the Internet. Content owners and content distribution companies from all parts of the globe (new and old) are working to position themselves in such a way as to profit from consumers selecting their valuable content rather than content titles offered by their competitors.

It is therefore critical that such a hybrid system as presented in this patent application allows consumers to easily connect to the web and play content selections in virtually any manner they desire. Even though some titles may be protected by DRM systems and methods, these titles can still be enjoyed by consumers as long as the necessary requirements to play the titles are fulfilled.

The term “Over-The-Top” refers to the delivery of content over the open Internet. Therefore, such a Hybrid system as defined in this patent application will support “Over-The-Top” content delivery methods.

Given the vast number of content selections available “Over-The-Top” (over the web), powerful video search systems and methods will be needed to locate content titles that may be appealing to consumers. It is important within this hybrid approach that very powerful video search means be used in order to locate content titles that are important or otherwise meaningful to the consumers of such a product.

It is envisioned that millions of people will enjoy digital terrestrial television experiences within the first decade of the 21st century alone. This is due to a number of reasons as follows:
The removal of analog television signals
The very high quality resolution (including high-definition)
The very low cost (basic equipment—no charge for broadcast data)
The fact that digital terrestrial may provide all of the television shows that a person or family may desire to watch
And other reasons.

It is the case today that many villages in outlying areas of the world are populated with humble homes (even huts) fully equipped with antennas and components that are sufficient to play digital terrestrial television. It is also envisioned such a television experience located in these outlying areas will have government and advertising subsidies in order to help pay for these services.

In areas where streaming television presents a challenge to the existing infrastructure, such a Hybrid system may offer premium television viewing services and features that may not be available otherwise. While the consumers are watching free-to-air digital television, content can be downloaded and stored using an off-line process. Such a download feature will either take commands from the consumer and download selected titles, or the system may download titles based on viewing patterns and/or the profile of the consumer. In either case, such a download service will store content on long-term storage devices such as hard disc drives or high-capacity flash memory devices until the consumer decides to view, delete, or otherwise manipulate the title (as per the entitlements offered by the content owner(s).

At the time of this writing, an effective model for such a Hybrid service may couple Digital Terrestrial with WiFi (or WiMax) services. Therefore, the consumer may have no hard-wired connection. It is envisioned such a configuration may work best in remote areas of the world where service operators may find the wiring of communities to be cost prohibitive (or lacking an acceptable business model). Therefore, a WiFi or WiMax configuration may allow consumers living within such regions the ability to enjoy a premium television service even no hard-wire cables (or affordable premium satellite services) exist.

Whether the consumer has access to a hard-wire connection or a wireless connection, such a Hybrid system can offer real-time television broadcasts and “on demand” content by way of a network connection.

Although it is assumed that “on demand” content selections are either movies or television shows, other content titles can be offered through such a Hybrid system as follows:
Games
Skins and other embellishments to the system's user interface
Information relating to social networking sites
Search Indexes
Coupons and incentive programs
Pictures
Music
Many other types of content offerings . . .

Additionally, using all of the functionality as described in this patent application, consumers can use such a system to enjoy Social Networking experiences. For example, participants in a Social Networking venue may decide to watch one or more videos (terrestrial or “On Demand”) and use a backchannel (if it exists) to communicate with one another. Features such as on-screen displays of text and graphics can be used to facilitate the communications between the members of one or more social networking sessions.

The Hybrid Digital Terrestrial/IPTV system as defined in the patent application will have access to vast libraries of content via the collection of local content titles and the collection of international titles as well. Consumers will be able to use powerful and effective “Search” capabilities as (defined above) to locate titles that may have an interest or relevance to them.

As described above, these content titles aggregated from numerous sources can be transferred to the consumer's terminal device(s) by the following means:

A “Trickle” download of content in non-real-time mode. Such a “Trickle” method would be achieved using either a wireless or hard-wire approach. Over time, content titles would appear on a local storage device and, likewise, navigation tools will be available for consumers to view and select individual titles as desired.

A Fast-Download method which would allow the downloading of a content title within seconds using a protocol such as FTP (File Transfer Protocol). (Such a Fast-Download method differs from the “Trickle” method as it is much faster, although neither are real-time delivery methods.

The Real-Time stream of content titles using a network connection (wireless or hard-wire) as long as it is fast enough to handle the bit-rate required for the title.

It is well known that there are numerous wireless facilities and infrastructures that are available around the world that are not considered part of any broadcast television distribution system. For example, there are government-owned frequencies and systems other than those set made available for the purpose of providing television to consumers. The company, “Update Logic” has built a business around providing software updates to consumer electronic products by way of one or more of these alternative wireless systems. “Update Logic” can fix software bugs and make other modifications to systems in the field without the need for these systems have a hard-wire, Wi-Fi (or Wi-Max) connection.

A hybrid Terrestrial/IPTV system as described in this patent application can make use of these alternative wireless facilities for the following purposes:
Periodic Software Updates
New Features and Functions
Information important for Support and Customer Care personnel
Targeted Advertisements
Coupons and other types of incentives for consumers
And even additional Content titles
Other information that might be relevant or important to the consumer.

It is envisioned that a “Call Center” will be important as such a Hybrid Digital Terrestrial/IPTV system will be very attractive to a very large base of consumers. Likewise, these consumers will have an interest in some of the incentive programs being offered by advertisers as this may help them to save money as they enjoy valuable incentives that are offered to them from time to time. Therefore, incentive programs by way of coupon distribution processes and other incentive programs may require a “Call Center” in order to further develop the relationship between the advertiser and the consumer. Although “Call Centers” have the appearance of being telephone centric facilities (only), these “Call Centers” can be based around Internet chats, email messages, SMS messages, and other consumer-level feedback facilities that might be available from the consumer's terminal device.

In a preferred embodiment, such a Hybrid unit will be pre-engineered to contain state-of-the-art content security means including (but not limited) to the following:
Public Key Infrastructure (PKI)
AES 128 (or greater)
SSL
HDCP
Macrovision or Dwight Cavendish analog protection systems
Digital Video Watermarking
Cloakware
Other systems used to obfuscate keys and encrypt digital image frames.

The well known company Verimatrix, Inc. located in San Diego, Calif. has developed numerous content security technologies including a robust digital video watermark that can be used for the systems and technologies presented in this patent application.

The Middleware system for such a hybrid offering will be critically important as it will need to have all of the best-of-breed functions and features, however, it must also have a small footprint and be able to operate under numerous (less than advantageous) conditions. Since a main target for such a device is the hundreds of millions (or possibly billions) of people around the world who are either enjoying a middle class life style or will soon be joining the middle classes, the middleware systems must provide a state-of-the-art (intuitive) user interface and must provide all of the features and functions necessary for the best possible viewing experience (even though the service is less sophisticated than the large U.S. MSOs including Comcast, Time Warner, Cox, etc).

Furthermore, in countries such as India, China, The Philippines, Indonesia, parts of Africa, television viewing was not necessarily available at home. Now that more people are starting to enjoy the benefits of a steady pay-check and the benefits of the new infrastructures established by their countries, these same citizens will desire a television set and the companion programming and services that will provide them with the best possible experience given their budgets. One companion service is the middleware system that will provide the Electronic Program Guide (EPG) and the connection to the other services and systems necessary to all participants in the distribution supply chain.

The middleware system for this Hybrid system will therefore have the following advantages:

Small footprint (minimum amount of software code) for the terminal device(s)

Low-Cost

Robust server-side systems

Allows for content (and other resource) management and distribution

Allows for Cross-Platform content play-back on numerous terminal devices

Allows for Digital Video Recording

Allows for bookmarking (so alternative terminal devices can continue play-back)

Fully featured Electronic Program Guild (EPG)
Allows for International Content Aggregation and Distribution
Allows for “On-Demand” content plays
Numerous other next generation features designed for Television Systems.

Although the targeted demographic for such a Hybrid unit is an individual (or family) of modest means, it is still envisioned such an individual (or family) will purchase numerous terminal devices as they progress up the economic ladder. People living on small salaries will most likely have at least one television set, however, people living on modest salaries will most likely own an MP3 player, mobile phone (possibly video enabled), a PC, and a television set. Therefore, Cross-Platform support will be a requirement for such a Hybrid system.

The Middleware system will allow for device registration for the consumer. By way of a web portal or a phone call to the video service operator, the consumer can indicate the various terminal devices that can be used to for “play-back”. When content plays are requested for these additional terminal devices, the middleware will simply check to verify the terminal devices are appropriately “registered”, and then content will play seamlessly. Such a verification process will use terminal device information such as:

Manufacture

Model Number

Serial Number

Other relevant information that can be obtained.

The second method to support Cross-Platform services is the use of Bookmarks. The consumer can pause the stream (or “On Demand” session) of a content play, and the Middleware system will place an appropriate bookmark within the content file so other devices can locate the bookmark and continue play without interruption.

There are two methods that can be used to support multiple screen formats and resolutions used by the various popular terminal devices. The two methods are as follows:

a. Multiple content files can be ingested for each content title. The preferred embodiment for this patent application is for consumers to register their terminal devices so the screen format parameters can be determined. Upon a request for content to be directed to a given terminal device, the appropriate file will be sent from the content server system to the terminal device. This file will already be encoded using the correct format and screen resolution.

b. Encoder systems and transcoding systems can be strategically placed within the content distribution network in order to perform the necessary formatting procedures on an “as needed” basis (or “on-the-fly”) in order to provide an acceptable playback experience.

The foregoing has outlined some of the more pertinent objects and general operating principles of the method and apparatus herein. These should be construed to be merely illustrative of some of the more prominent features and applications of the intended invention. Many other beneficial results can be attained by applying the disclosed method and and apparatus herein in a different manner or by modifying the invention within the scope of this disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

The accompanying drawings, which are incorporated in and form a part of this specification, illustrate embodiments of the invention and together with the detailed description, serve to explain the principles of this invention.

FIG. 1 depicts a preferred embodiment for such a Digital Terrestrial/IPTV Hybrid unit.

FIG. 2 depicts how the system can be configured in such a way as to plug into the HDMI connector of a high-definition television set.

FIG. 3 depicts three different profile groups and three different RT-EPGs.

### DETAILED DESCRIPTION OF PREFERRED EMBODIMENTS

Taking the previous summary of invention and referring now to the drawings, wherein similar parts of the invention are identified by like reference numerals, there is described, and seen in the figures, the preferred embodiments for such a Digital Terrestrial/IPTV Hybrid unit.

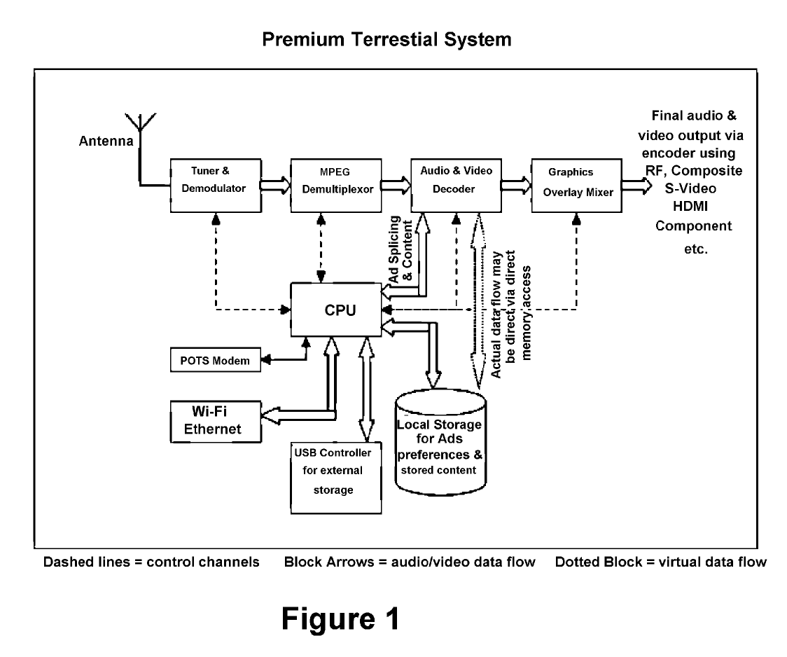

In FIG. 1, the system is depicted and the dashed lines represent the control channels. The Block arrows represent the audio/video data flow. The Dotted block arrows represent the virtual data flow.

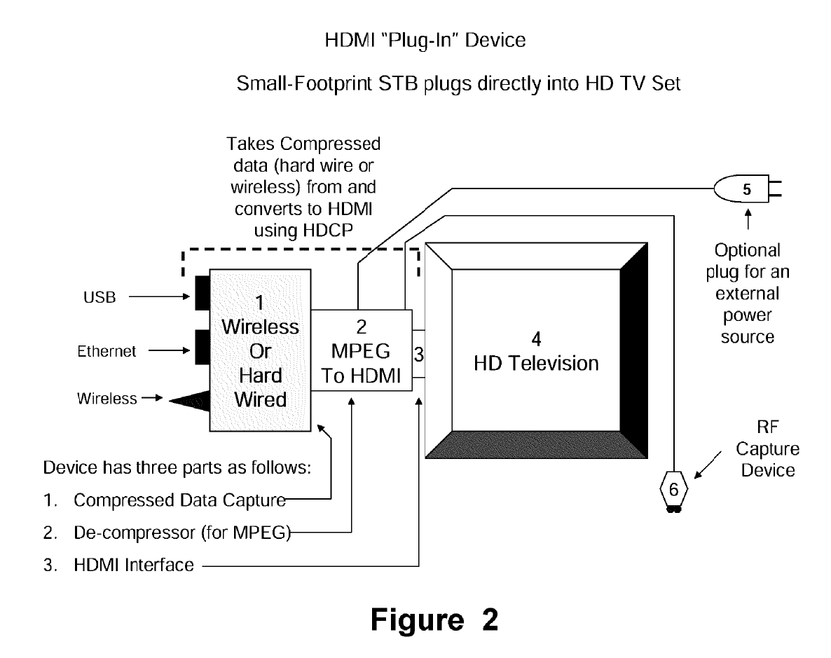

In an alternative embodiment also preferred, such a Digital Terrestrial/IPTV Hybrid unit can be configured in such a way as to plug into the HDMI connector of a high-definition television set as described in FIG. 2.

Among the most important new paradigms for television is the targeting of advertisements. In numerous television platforms today, the targeting of advertising is taking place at some level. In some cases, ads are inserted into a broadcast stream (or within an “On-Demand” content play) based on the geographical region of the consumer.

In other cases, the consumer's profile will dictate the ad that will be spliced into his or her broadcast stream. In other cases, ads are delivered based on other criteria such as other content titles that were previously selected by the consumer, or other external data elements that exit for the consumer. It is envisioned that targeted advertising over broadcast television will become a standard practice as advertisers look to maximize their investment and as consumers learn targeted advertising can result in a more relevant experience as well.

With this in mind, it is also possible to offer the consumer a Relevant Targeted Electronic Program Guide (RT-EPG). Such a RT-EPG will search for relevant and otherwise potentially desirable content titles for the consumer and arrange them in such a way as the consumer can access them in a manner in which they are familiar.

In the early days of television, consumers became accustomed to changing the knob on their television set in order to advance from one television station to the next. Within a number of years, the remote control unit was introduced, allowing consumers to advance from one station to the next without physically touching the television set. As the Internet became popular in the late '90s and into the first decade of the 21st century, numerous tools were devised to search, locate, and play content titles.

The problem is the disenfranchisement of hundreds of millions of television viewers who fall into one or more of the categories defined below:

Consumers who do not use the Internet on any consistent basis, and are unfamiliar with Internet-based navigation systems and tools.

Consumers who are familiar with Internet-based systems and tools, however, are not interested in using those methods when it comes to watching television.

Consumers who are familiar with Internet-based systems and tools, and are prepared to use them, however, the video service provider's systems and networks are so poor, the experience is unsatisfactory.

Consumers who are otherwise not interested or inclined to use new modes of searching and selecting content for viewing within a television environment for any reason.

Therefore, the concept of a RT-EPG becomes compelling. The system will automatically search for content titles and arrange them in such a way as they appear to be available within the video service provider's own EPG. In fact, this is not part of the video service provider's standard EPG. This is a discrete application program that mimics the well-known EPG metaphor by filling it with “On-Demand” titles that appear as if they are in the general broadcast television “line-up”.

In a preferred embodiment for such a RT-EPG has the system perform the following functions:

1. Continuously search for relevant and compelling content titles based on information about the consumer and the preferences (if any) that have been set.

2. When titles are discovered, the system will check for licensing terms and conditions.

3. If the licensing terms and conditions appear to be acceptable (given what is known about the consumer and by way of educated guesses), the titles will be populated into the RT-EPG.

4. When the consumer is interested in checking the RT-EPG, he (or she) will be able to see numerous interesting titles already queued-up and ready to start playing at any time.

5. If the consumer were to press a “Select” button (in an attempt to select a content title), the content title will play as if it was already playing as part of the general broadcast television “line-up” at that time.

6. If the consumer must pay for the title, or otherwise perform a service or function (such as watching an advertisement), then the consumer will be prompted accordingly. When the consumer completes the ordering processes successfully, then the content title will play.

It should be noted that all of the content titles within the RT-EPG are “On-Demand” sessions. This method is simply a way to reduce the effort and complexity of searching and ordering content titles by providing a metaphor that is very well known to consumers world-wide. Therefore, when the consumer performs a “Select” function, an “On-Demand” session is initiated (although it appears to be part of the broadcast television offering at that time).

The RT-EPG can also offer a “time-warp” feature because the EPG is only a metaphor for an underlying library of on-demand content. If a viewer selects a program which is listed to start in the future, the system can offer to start the program immediately. The system operator may also choose to offer this time-warp feature for a fee. For example, a $5.00 movie could be started immediately by paying 50 cents more.

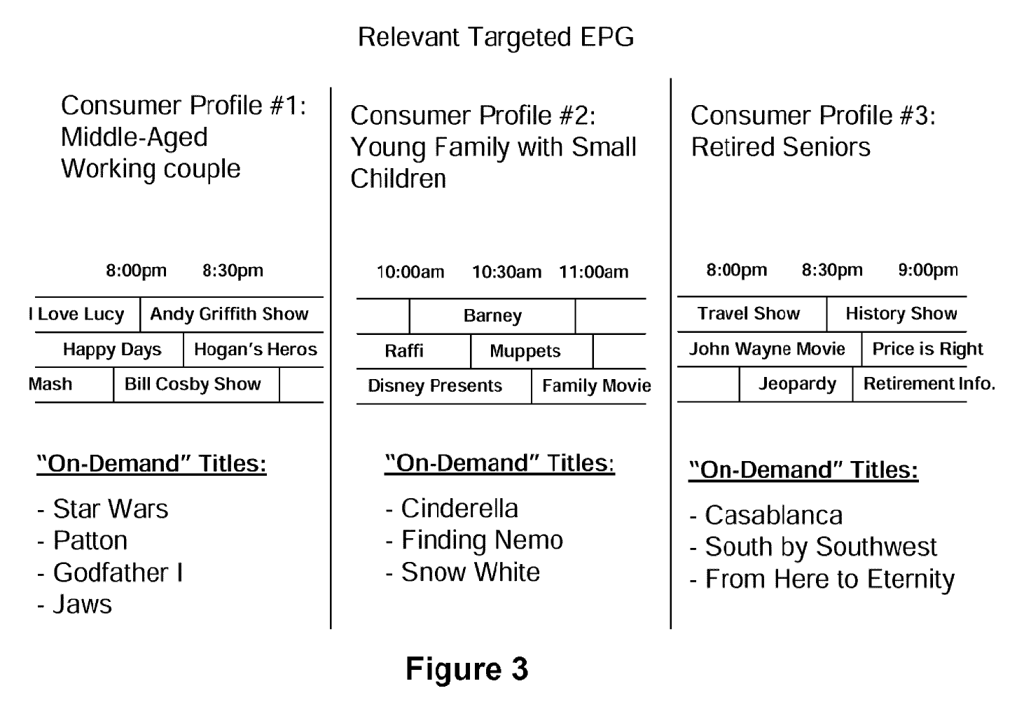

As seen in FIG. 3 there are depicted three different profile groups and three different RT-EPGs. It should be noticed that the first profile group is a middle-aged working class couple. The content titles within their EPG are designed to be as compelling as possible for them. The second profile group is a young family. Numerous content titles created for the children's market can be selected. In the third profile group, content titles appropriate for seniors is available. It should be noted that content titles can be completely unique for each profile group (although in a real-world experience, there may be a great deal of overlap).

Shown at the bottom of each RT-EPG in FIG. 3 are additional content titles that can be played as “On-Demand” titles should the consumer venture to navigate and make their selections using more of an Internet style metaphor.

It is important to note that the profile groups displayed in FIG. 3 can live in the same apartment complex, or in different states, or even different countries. The preferred embodiment for this application is the targeting to be performed based on the profile of the household. Not the geographic region where the consumer is watching television.

As such, the Digital Terrestrial/IPTV Hybrid unit is designed for huge populations of consumers who wish to have the highest definition television possible at a cost that is fundamentally free, however, offers a-la-carte content selections when the consumer is so inclined to pay the appropriate fees. Such an offering is similar to some of the best premium television services in the world, however, offers a tiny overall price in comparison.

While all of the fundamental characteristics and features of the apparatus and method for enhanced delivery of terrestrial television have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A method for the provision of a hybrid premium television platform as described herein and shown in the drawings.
